(19) United States
(12) Patent Application Publication
(10) Pub. No.: US 2003/0226792 A1
(43) Pub. Date: Dec. 11, 2003

(54) Multilayer filter element

(75) Inventors: Manfred Tumbrink, Eberstadt (DE); Joachim-Paul Krieger, Reisbach (DE); Gunnar-Marcel Klein, Weilheim-Teck (DE)

Correspondence Address: CROWELL & MORING LLP, INTELLECTUAL PROPERTY GROUP, P.O. BOX 14300, WASHINGTON, DC, 20044-4300, US

(73) Assignee: Filterwerk Mann & Hummel GmbH

(21) Appl. No.: 10/441,097

(22) Filed: May 20, 2003

Related U.S. Application Data
(62) Division of application No. 09/856,526, filed on Sep. 6, 2001, now abandoned.
Application No. 09/856,526 is a 371 of international application No. PCT/EP99/08975, filed on Nov. 20, 1999.

(30) Foreign Application Priority Data
Nov. 26, 1998 (DE) 198 54 565.7

(51) Int. Cl. B01D 39/18

(52) U.S. Cl. 210/168; 210/171; 210/490; 210/493.1

(57) ABSTRACT

The invention relates to a multi-layer filter element. The invention provides a main filter layer which preferably consists of a melt-blown fleece and has an absolute filtration capability. A paper layer (2) on the clean side supports the filter element and does not contribute to the filtering of the fluid to be filtered. Said layer can therefore have a macropore structure, thereby allowing a low flow resistance. A layer (3)on the clean side which preferably also consists of paper serves to pre-filter the fluid and to protect and support the main filter layer. The inventive design of the multi-layer filter material provides a means for economically producing filter elements, especially filter cartridges which are folded in the shape of a star, since no trellis protective layers are necessary. The invention also facilitates an improved thermal disposability of the proposed filter cartridge.

### BACKGROUND OF THE INVENTION

The invention relates to a multilayer filter element for liquids.

Multilayer filter media are known in the art. U.S. Pat. No. 5,427,597, for instance, discloses a filter for gaseous substances in which fibrous prefiltering layers are applied to a filter paper. This filter paper is responsible for the absolute filtering of the gas to be filtered. The filter material may be processed into a cartridge-type unit. Cylindrical support tubes are provided for stabilization.

For the filtration of liquids, fibrous filter media, made of glass fibers for instance, are also used for the absolute filter stage. These nonwoven webs are highly sensitive, however, and must therefore be protected by further layers. Particularly when pressure differences between the unfiltered and the filtered side are high, wire-type mesh or rolled mesh is used as described, for instance, in U.S. Pat. No. 5,215,661. This wire mesh can protect the nonwoven filter medium against collapse toward the filtered side of the filter. But the mesh is too coarse to prevent fraying of the nonwoven material. As a result, additional spunbond materials must be provided to protect the surface of the main filter layer. Consequently, the construction of such filter elements is complex, and their thermal disposal is made more difficult due to the metallic components or different types of plastic.

### SUMMARY OF THE INVENTION

The object of the invention is thus to create a multilayer filter element, which is cost-effective to produce and simple to dispose of, and which is suitable for use with high pressure differences between the unfiltered side and the filtered side of the filter element.

This object is attained by the invention as described and claimed hereinafter.

According to the invention, this object is attained in that a multilayer filter element has a predominantly cellulose-containing filter paper as the layer on the filtered side. Additional filter layers may be applied to this filter layer. These layers comprise at least one nonwoven main filter layer, which may be made of glass fibers; other fibrous filter materials are also feasible. Furthermore, at least one unfiltered-side layer must be applied to the main filter layer to protect the latter. Different materials may be used for this purpose, e.g., a spunbond material.

The filter layer on the filtered side, which is made of paper, is less fine than the main filter layer. The main filter layer, therefore, is responsible for absolute filtration of the medium to be filtered. The function of the paper layer is thus merely to provide support. This has the essential advantage that the paper can be designed for this function. It makes it possible to use a highly stable paper, and a very coarse filter quality can be deliberately selected. Consequently, an excessive increase in the flow resistance at the filter element due to a large paper thickness on the stable, filtered-side layer can be prevented. The filtered-side layer is in any case made fine enough, however, to prevent fraying of the main filter layer. This eliminates the requirement for an additional spunbond material between the filtered-side layer and the main filter layer, which would be necessary, for instance, if a wire mesh were used as the filtered-side layer.

The filtered-side layer constructed in this way does not participate in the filtering process. In the absolute filtration provided by the main filter layer, the deep filtration effect of the employed filter medium is primarily used. Due to the effective filtered-side support, the main filter layer can be designed solely for the best possible deep filtration effect. The fibers used may have a small diameter, since the pore size of the paper, which forms the filtered-side support layer, is in any case sufficient to retain the fibers. The main filter layer can furthermore be very loose, i.e., designed for a high storage capacity for removed particles. The filter fineness of the main filter layer may increase toward the support layer, which enhances the deep filtration effect, since coarse particles are separated in the unfiltered-side area of the main filter layer and finer particles in the filtered side area of the main filter layer. However, the filter fineness of the main filter layer on the filtered side must be selected such that the particles to be filtered out are retained by the size limit defined for the application. The support layer cannot assume any reliable filter function since the pore size of this layer is too large for this purpose.

The use of paper as a support layer without a filtering function can thus replace the described support means comprising a wire mesh and spunbond material. This results in a simpler construction of the multilayer filter medium, which affects the economic efficiency of the resulting filter elements. It furthermore creates a metal-free filter unit, which can be disposed of without problems. For instance, the filter can be completely incinerated.

According to an advantageous embodiment of the inventive concept, the unfiltered-side layer, in addition to the function of protecting the main filter layer, also assumes the function of prefiltering the fluid to be filtered. To this end, the filter fineness of the unfiltered-side layer must be selected in such a way that the coarse component of the particles to be filtered out is separated in the unfiltered-side layer. This increases the service life of the filter. It also makes it possible to clean off the unfiltered-side layer regularly, which further increases the filter service life.

The unfiltered-side layer advantageously also comprises a filter paper containing predominantly cellulose. In addition to the protective function for the main filter layer and possibly a prefiltering function, this layer can simultaneously assume a support function. This creates a three-stage composite with a paper layer on each of the unfiltered and the filtered sides and at least one nonwoven main filter layer. Unlike multi-layer filters with wire mesh layers or other mesh-type plastic support layers used for stabilization, this composite may be processed using the folding techniques of conventional paper filters. This processing technique is substantially more economical, since the folded wire mesh layers are more difficult to handle. Using paper end layers, in particular, makes it possible economically to produce star-folded filter elements on rotating embossing and folding machines.

The use of so-called meltblown nonwovens as one layer of a filter medium is extremely advantageous, since these materials have a very high storage capacity for particles which are filtered out and offer low flow resistance for the medium to be filtered. This advantage is obtained due to the small fiber diameters (approximately <2 μm) and due to the high porosity of the meltblown nonwoven material. The filter action, particularly the separation rate, initially increases during the life of the filter with the retention of filtered out particles. The filter fineness of the inflow side layer is selected such that this fine layer ensures a sufficiently long service life of the filter element.

Specifically, advantageous embodiments can be created by using at least one meltblown nonwoven material with a weight per unit area of approximately 15 to 150 g/m². A starting material suitable for the meltblown nonwoven fabric is, for instance PP (polypropylene), particularly for non-aggressive liquids, or PES (polyether sulfone), which may also be used to filter fuel or hydraulic oils. The meltblown nonwoven fabric may be calendered.

An advantageous further development of the filter layers according to the invention provides for star-folding the joined layers of the filter media to form the filter element. In particular, the layers of the filter media can be ultrasonically welded before or during folding, or joined by surface pressure during the folding process, for instance in an embossing and folding machine. The layers may also be bonded with an adhesive, in which case a powdered adhesive or a hot-melt impregnating material may also be used.

The cellulose-containing filter paper may also have a content of up to 50% of other materials, e.g., glass fibers or polyester fibers.

The filter element according to the invention may be used, for instance, in oil filter systems, particularly for motor vehicles. Combinations of a few basic elements for the filter media adapted to the respective application make it possible to vary the filter properties widely by relatively simple means to achieve an increased service life at the existing overall volume, high shape stability against pressure differences between the unfiltered and the filtered side, and low flow resistance.

These and other features of preferred further developments of the invention are set forth in the claims as well as in the description and the drawings. The individual features may be implemented either alone or in combination in embodiments of the invention or in other fields of application and may represent advantageous embodiments that are protectable per se, for which protection is hereby claimed.

### BRIEF DESCRIPTION OF THE DRAWINGS

Further details will now be described by way of example, with reference to schematic embodiments depicted in the drawings in which

FIG. 1 is a cross section through a three-ply filter material, in which a nonwoven filter material is enclosed by two paper layers.

FIG. 2 is a cross section through a sector of a star-folded filter cartridge, where a main filter nonwoven material is enclosed on the filtered side by a paper layer and on the unfiltered side by a spunbond material.

### DETAILED DESCRIPTION OF PREFERRED EMBODIMENTS

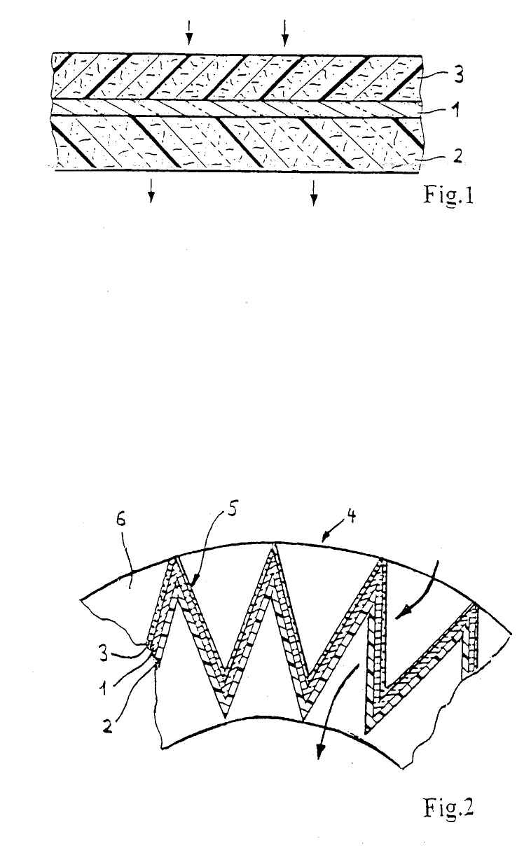

FIG. 1 shows a three-ply filter material. The flow direction through the filter material of the fluid to be filtered is indicated by an arrow. The main filter layer 1, which is comprised of a meltblown nonwoven material, ensures absolute filtration. A filtered-side layer 2 is comprised of a filter paper with low flow resistance. This filter paper merely serves to support the filter material and to protect the filtered-side surface of the meltblown nonwoven material 1. Furthermore, an unfiltered-side layer 3 made of filter paper is provided. This paper layer provides additional support in interaction with the filtered-side layer 2. It also protects the filtered-side surface of the meltblown nonwoven material. The filter fineness of the unfiltered-side layer 3 is moreover selected such that a preliminary separation is effected as the fluid to be filtered flows therethrough.

Possible starting materials for the meltblown nonwoven fabric include, for instance, PP (polypropylene), particularly for non-aggressive liquids, or PES (polyether sulfone).

For further processing of the filter layers described by means of FIG. 1, the layers of the filter media, which are joined together as shown in the sketch of FIG. 2, are star-folded to form a filter element 4. The layers of the filter media may be ultrasonically welded before or during folding, or joined by bonding or by surface pressure during the folding process, for instance in an embossing and folding machine.

The fluid may flow through the filter element according to FIG. 2 in radial direction either from the outside to the inside or from the inside to the outside, depending on the corresponding application. The filter material 5 is inserted in end disks 6, which may for instance be configured as foil end disks. The unfiltered-side layer 3 may alternatively be configured as a spunbond nonwoven material with a weight per unit area of, for example, 17 g/m².

1. Filter element for liquids, in which several layers of filter media succeed one another as viewed in flow direction, wherein at least one filtered-side layer (2) of a predominantly cellulose-containing filter paper, one nonwoven main filter layer (1), particularly made of glass fibers, and one unfiltered-side layer (3) are provided, characterized in that the unfiltered-side layer (3) and the filtered-side layer (2) have a lesser filter fineness than the main filter layer, which is intended for absolute filtration of the fluid to be filtered.

2. Filter element as claimed in claim 1, characterized in that the unfiltered-side layer (3) has a filter fineness that represents a barrier for the coarse particles in the fluid to be filtered.

3. Filter element as claimed in any one of the preceding claims, characterized in that the unfiltered-side layer (3) consists of a predominantly cellulose-containing filter paper.

4. Filter element as claimed in any one of the preceding claims, characterized in that the main filter layer consists of a calandered meltblown nonwoven material with a weight per unit area of 15 to 150 g/m².

5. Filter element as claimed in any one of the preceding claims, characterized in that the joined filter media are star-folded to form the filter element (4).

6. Filter element as claimed in any one of the preceding claims, characterized in that the layers (1, 2, 3) of the filter media are ultrasonically welded.

7. Filter element as claimed in any one of claims 1 to 7, characterized in that the layers (1, 2, 3) of the filter media are joined by surface pressure during a folding process.

8. Filter element as claimed in any one of claims 1 to 7, characterized in that the layers (1, 2, 3) of the filter media are joined by bonding with a powdered adhesive or with a hot-melt impregnating material or by surface pressure during a folding process.

9. Filter element as claimed in any one of the preceding claims, characterized in that one or several of the cellulose-containing filter layers (2, 3) have a proportion of up to 50% of synthetic fibers, particularly polyester or glass fibers.

10. Filter element as claimed in any one of the preceding claims, characterized in that the filter element is used as a full flow or partial flow filter in an oil or fuel filter system, particularly for a motor vehicle.
